(19) United States
(12) Patent Application Publication
(10) Pub. No.: US 2007/0266978 A1
(43) Pub. Date: Nov. 22, 2007

(54) Self-Igniting Petrol Internal Combustion Engine

(75) Inventors: Thierry Duverger, Le Plessis Robinson (FR); Elodie Deharte, Boulogne-Billancourt (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy-Villacoublay (FR)

(21) Appl. No.: 10/551,826

(22) PCT Filed: Mar. 19, 2004
(86) PCT No.: PCT/FR04/50115

§ 371 Date: Jun. 26, 2007

(30) Foreign Application Priority Data
Apr. 4, 2003 (FR) 0304231

(51) Int. Cl. F02B 1/12

(52) U.S. Cl. 123/143 A

(57) ABSTRACT

The invention relates to a self-igniting gasoline internal combustion engine comprising at least one cylinder (1), a cylinder head (2) closing the cylinder (1), a piston (3) mounted in the cylinder (1) in a sliding manner, a combustion chamber (4) which is defined in the cylinder (1) between an upper face (3) of the piston (3) and a lower face (20) of the cylinder head (2), a means (5) for injecting gasoline into the combustion chamber (4), admission valves (7) and exhaust valves (8) which selectively close the combustion chamber (4), and an injection pump (8) for supplying the injector (5) with gasoline under pressure. According to the invention, the air-gasoline mixture is spontaneously ignited and the pressure of the gasoline supplied to the injector exceeds 250 bar.

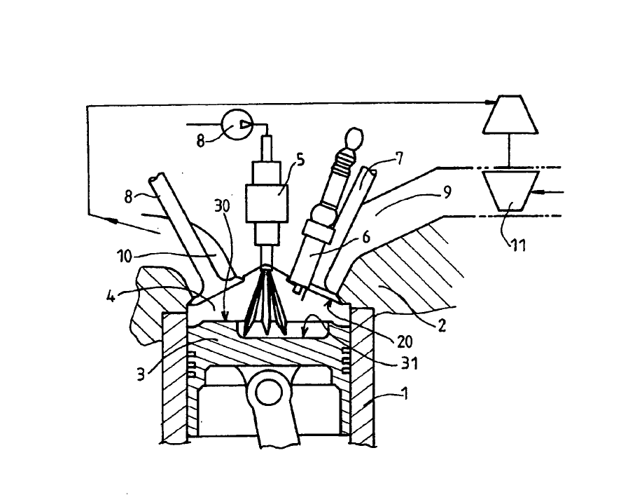

The invention concerns a self-igniting gasoline internal combustion engine.

The invention concerns more particularly a self-igniting, gasoline internal combustion engine comprising at least one cylinder, a cylinder head closing the cylinder, a piston slidingly arranged in the cylinder, a combustion chamber defined in the cylinder between an upper face of the piston and a lower face of the cylinder head, means for injecting gasoline into the combustion chamber, admission and exhaust valves closing selectively the combustion chamber, an injection pump intended to supply pressurized gasoline to the injector.

In such a self-igniting engine, ignition of the air-gasoline mixture is obtained spontaneously in at least one range of operation of the engine thanks to thermodynamic conditions in the combustion chamber, i.e., without energy supply in the form of a spark. To reach this objective, it is possible to use in particular a high rate of residual gases, i.e., reusing of the burned gases from the preceding combustion, to increase the temperature of the air-gasoline mixture.

Thus, since the ignition is a function of the thermodynamic conditions in the combustion chamber (pressure, temperature . . . ), it is difficult to master precisely the control of this combustion and in particular the time at which it is triggered.

This type of self-igniting engine makes it possible to obtain combustions with a very low level of polluting emissions, which is due in particular to the lower combustion temperatures, as compared to the case of a combustion obtained by controlled ignition via a spark plug, thanks to a high dilution of the mixture.

However, in the stratified direct injection mode (i.e., with a non-homogeneous mixture), the rate of pollutant emission, in particular NOx, is higher.

An objective of the present invention is to remedy all or part of the drawbacks of the prior art mentioned above.

To this effect, the self-igniting gasoline internal combustion engine according to the invention, which is otherwise conform to the generic definition given in the preamble above, is essentially characterized in that the pressure of the gasoline supplied to the injector is above 250 bars.

Further, the invention can comprise one or several of the following characteristics:
the pressure of the gasoline supplied to the injector reaches or is above 500 bars,
the gasoline injection is made in a time period situated at the end of the load compression cycle by the piston,
the gasoline injection is made in a time interval comprised between 60 degrees crankshaft before the high dead center of the combustion cycle and 20 degrees crankshaft after the high dead center,
the engine comprises means for supercharging the intake air intended to supply the combustion chamber,
at least in an range of operation of the engine, the amount of gasoline delivered by the pump to the injection means for a combustion cycle is fractionated in the form of a plurality of partial and distinct injections,
the engine comprises at least a partial injection delivered during the air intake phase into the combustion chamber of during the first portion of the compression phase, and at least a partial injection delivered around the high dead center, i.e., at a time interval comprised between 60 degrees crankshaft before the combustion dead center and about 20 degrees after that high dead center,
the engine comprises ignition means intended to produce ignition of the air-gasoline mixture in the combustion chamber during the so-called very-low-load or very-heavy-load ranges of operation,
the engine uses a ratio of residual gases above 20%, and, preferably, above 50% (in particular at very low load),
the engine uses a variable compression rate,
the engine is a direct injection engine of the type in particular with direct jet or pseudo-direct jet or deflected jet,
the engine has a variable distribution system to ensure an internal recirculation of the exhaust gases.

Other particularities and advantages will appear by reading the following description made in reference to the only FIGURE which is a schematic cross-section view of an internal combustion engine according to the invention.

In the embodiment shown, the internal combustion engine with direct injection of gasoline and self-ignition comprises at least one cylinder 1, a cylinder head 2 closing the cylinder 1, a piston 3 slidingly arranged in the cylinder head 1 and connected to a crankshaft (not shown). A combustion chamber 4 is defined between an upper face 30 of the piston 3 and a lower face 20 of the cylinder head 2.

A means 5 for injecting gasoline such as an injector is disposed in the cylinder head 2 so as to open into the combustion chamber 4. The engine comprises an injection pump 8 intended to supply pressurized gasoline to the injector 5.

The engine also comprises intake valves 7 and exhaust valves 8, intended to close selectively passages between the combustion chamber 4 and, respectively, an intake conduit 9 and an exhaust conduit 10.

Classically, ignition of the air-gasoline mixture is obtained spontaneously in at least one range of operation of the engine thanks to the thermodynamic conditions in the combustion chamber 4.

The engine comprises also an ignition means 6 such as a spark plug intended to produce ignition of the air-gasoline mixture in the combustion chamber 4 during the so-called “very low load” or “very high load” ranges of operation during which the spontaneous inflammation is not possible or not desired.

According to the invention, the pressure of the gasoline provided to the injector 5 is above 250 bars. In a preferred embodiment, the pressure of the gasoline provided to the injector 5 is comprised between 300 and 2,000 bars. For example, the pressure of the gasoline provided to the injector 5 reaches or is above 500 bars.

The injection according to the invention ensures a quick atomization of the gasoline into fine droplets and confers a high amount of movement to the injected gasoline. An increase in the penetration speed of the gasoline into the chamber is thus obtained thanks to the invention. This more efficient penetration of the gasoline into the combustion chamber makes it possible to improve and to reduce the delay in the homogenization of the air-gasoline mixture. The polluting exhausts such as NOx and particles are thus reduced, as compared to the prior art.

The injection of gasoline can be made in a time interval situated during the compression cycle of the load by the piston 3, and, preferably, toward the end of the compression cycle.

The invention makes it thus possible to better monitor and control of the beginning of combustion of the air-gasoline mixture.

The applicant has observed that the triggering of the combustion is thus closer to the combustion high dead center, which makes it possible to improve the efficiency of the engine combustion cycle.

For example, this injection is made in a time interval comprised between 60 degrees crankshaft before the high dead center of the combustion cycle and 20 degrees after it.

Further, in the conventional gasoline engines with direct injection and self-ignition, the self-ignition of the air-gasoline mixture occurs essentially in the so-called “mid-load” or “low-load” ranges of operation, and in particular at engine speeds comprised between 1,000 and 4,500 revolutions per minute. The engine according to the invention makes it possible to widen the range of operation in self-ignition toward the low loads and toward the idling speed (toward speeds below 1,000 revolutions/minute and toward the heavy loads, in particular at high engine speeds (speeds above 4,500 revolutions/minute).

Indeed, at low load, the injection at very high pressure according to the invention makes it possible to reduce the need for residual gases.

Similarly, at higher loads, the high pressure injection according to the invention makes it possible to obtain a sufficient homogenization of the air-gasoline mixture to enable self-ignition, even in the case of a relatively late injection.

As shown on the FIGURE, the invention can be applied advantageously to a supercharged engine, i.e., comprising means 11 for supercharging the intake air intended to be supplied to the combustion chamber 4, such as a turbo-compressor.

In a particularly advantageous embodiment, at least in an range of operation of the engine, the amount of gasoline delivered by the pump 8 to the injector 5 for a combustion cycle is fractionated in the form of a plurality of partial and distinct injections. For example, at least one partial injection is delivered during the air intake phase into the combustion chamber 4, to form an air-gasoline mixture; and at least one partial injection is delivered around the high dead center, i.e., at a time interval comprised between 60 degrees crankshaft before the combustion high dead center and 20 degrees crankshaft after the latter, to control combustion of the mixture.

Preferably, the engine has a variable distribution system to ensure an internal recirculation of exhaust gases (IGR).

1. Self-igniting gasoline internal combustion engine comprising at least one cylinder, a cylinder head closing the cylinder, a piston slidingly arranged in the cylinder, a combustion chamber defined in the cylinder between an upper face of the piston and a lower face of the cylinder head, means for injecting gasoline into the combustion chamber, intake valves and exhaust valves selectively closing the combustion chamber, an injection pump intended to supply the injection with pressurized gasoline, the ignition of the air-gasoline mixture being obtained spontaneously in at least a range of operation of the engine thanks to thermodynamic conditions in the combustion chamber, wherein the pressure of the gasoline provided to the injector is above 250 bars.

2. Engine according to claim 1, wherein the pressure of the gasoline provided to the injector reaches or is above 500 bars.

3. Engine according to claim 1, wherein injection of the gasoline is made in a time interval situated at the end of the cycle of compression of the load by the cylinder.

4. Engine according to claim 1, wherein injection of the gasoline is made in a time interval comprised between 60 degrees crankshaft before the high dead center of the combustion cycle and 20 degrees crankshaft after the high dead center.

5. Engine according to claim 1, which comprises means for supercharging the intake air intended to be supplied to the combustion chamber.

6. Engine according to claim 1, wherein, at least in a range of operation of the engine, the amount of gasoline delivered by the pump to the injection means for a combustion cycle is fractionated in the form of a plurality of partial and distinct injections.

7. Engine according to claim 6, which comprises at least one partial injection delivered during the air intake phase into the combustion chamber or during the first part of the compression, and at least one partial injection delivered around the high dead center, i.e., at a time interval comprised between 60 degrees crankshaft before the combustion high dead center and 20 degrees after this combustion high dead center.

8. Engine according to claim 1, which comprises ignition means intended to produce ignition of the air-gasoline mixture in the combustion chamber during the so-called very low load or very high load ranges of operation.

9. Engine according to claim 1, which uses a ratio of residual gases above 20%.

10. Engine according to claim 1, which uses a variable compression ratio.

11. Engine according to claim 1, which is of the direct-jet or pseudo-direct-jet or deflected-jet type.

12. Engine according to claim 9, which uses a ratio of residual gases above 50%.
